(19) United States
(12) Patent Application Publication
(10) Pub. No.: US 2019/0144123 A1
(43) Pub. Date: May 16, 2019

(54) BACKPACK WITH A PARACHUTE COMPARTMENT

(71) Applicant: Elvis Carter, Fuquay Varina, NC (US)

(72) Inventor: Elvis Carter, Fuquay Varina, NC (US)

(21) Appl. No.: 16/188,464

(22) Filed: Nov. 13, 2018

Related U.S. Application Data
(60) Provisional application No. 62/584,801, filed on Nov. 11, 2017.

(51) Int. Cl. B64D 17/40

(52) U.S. Cl. CPC B64D 17/40

(57) ABSTRACT

A back pack with parachute that includes: a main compartment; and a chute compartment, wherein the chute compartment includes a releasable parachute. An air sensor is provided within the back pack, wherein the air sensor is adapted to enable the release of the parachute. Other features of the present invention include shoulder straps; a connection ring on the inside surface of the backpack; a waist strap extending from the connection ring; and leg straps extending from the connection ring. The air sensor includes an altimeter, wherein the altimeter enables the release of the parachute. The altimeter activates the release of the parachute after a predetermined distance alternatively a user may use a pull cord available on the back pack for manual activation.

### CROSS REFERENCE TO OTHER APPLICATIONS

This application claims priority to U.S. Provisional Application Ser. No. 62/584,801 filed on Nov. 11, 2017.

### BACKGROUND OF THE INVENTION

### Field of Invention

The present invention relates to a parachute compartment for use in emergency situations.

### Description of Related Art

High rise buildings present particular safety problems with respect to evacuation. Many highrise structures in cities can scan well over 50 to 100 floors. These buildings present safety concerns as any other building but particular concerns arise with multiple story buildings. A fire may require evacuation of the building, which requires individuals to use of steps in order to evacuate the building. Further because of the size of the building the evacuation process can take quite a significant amount of time. As a result, there may not be enough time to climb down or to traverse over the staircase to an exit at the ground floor. Further stairways may be blocked or become inaccessible due to fire or explosion. As a result, it would advantageous to have a companion device that individuals could use to essentially parachute from high floors of a multi-story building.

### SUMMARY OF THE INVENTION

The present invention relates to a back pack with parachute that includes: a main compartment; and a chute compartment, wherein the chute compartment includes a releasable parachute. An air sensor is provided within the back pack, wherein the air sensor is adapted to enable the release of the parachute. Other features of the present invention include shoulder straps; a connection ring on the inside surface of the backpack; a waist strap extending from the connection ring; and leg straps extending from the connection ring. The air sensor includes an altimeter, wherein the altimeter enables the release of the parachute. The altimeter activates the release of the parachute after a predetermined distance alternatively a user may use a pull cord available on the back pack for manual activation. Further, a storage pocket is available on an inner side of the backpack, where the storage pocket is adapted to store the waist strap and leg straps.

### BRIEF DESCRIPTION OF DRAWINGS

FIG. 1 depicts a rear view of a backpack equipped with a parachute in accordance with the present invention.

FIG. 2 depicts an inside view of the backpack with parachute according to the present invention.

### DETAILED DESCRIPTION

The present invention relates to a backpack that is equipped with a parachute compartment. The parachute compartment of the backpack contains a parachute that enables a user to release and utilize as a conventional parachute.

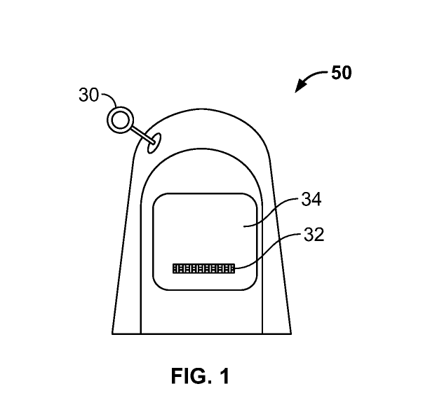

A backpack 50 is shown in FIG. 1, where a rear view of the backpack 50 is visible. The backpack 50 has a similar shape and sizing of a conventional backpack but includes a parachute compartment 34 on the outside surface thereof. The parachute compartment 34 contains a parachute that is released with a pull cord 30 as shown in FIG. 1, the pull cord 30 is used as a backup device. An air sensor 32 is also provided on outside of the suit compartment. The air sensor 32 activates the release of the parachute, where the air sensor 32 is an altimeter and will automatically open the parachute without any need for the user to use the pull cord 30. The air sensor 32 functions as activation sensor so when the user falls a predetermined distance then the parachute is released.

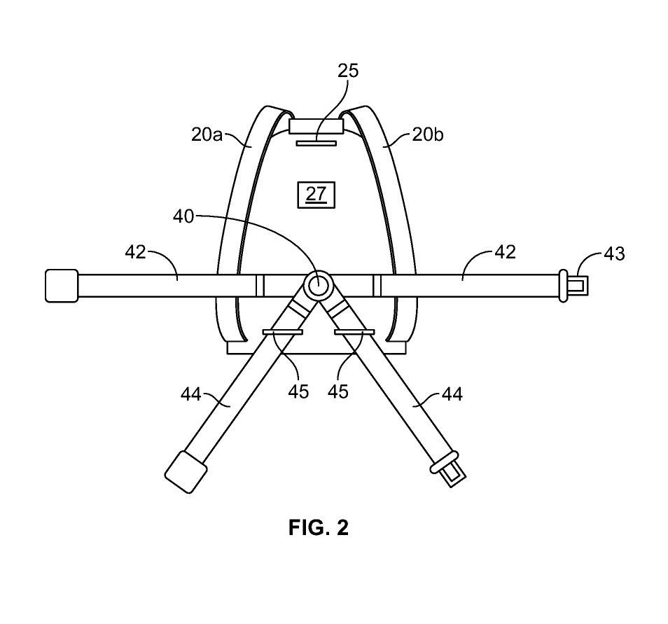

An inside surface of backpack 50 is shown in FIG. 2. On the inside surface, shoulder straps 20a, 20b are shown to extend from the top of the backpack 50 to the bottom thereof. The shoulder straps 20a, 20b engage onto the user's shoulders and may be used as a backpack or the user may activate the parachute in an emergency. A pouch 27 is shown at the center of the inside surface that may be used to contain any additional items as desired by the user. A cellular phone pocket 25 is shown at the top of the backpack 50 for insertion of a cellular phone. Additional strapping is also provided in this backpack. This additional strapping is engaged when the backpack is used as a parachute. Waist belt 42 is shown with buckle 43. Further leg straps 44 are also shown with buckles to engage the straps 44 around a user's legs. These straps 44 are stored within storage pockets 45 shown at the bottom of the backpack. These storage pockets conceal the straps until engaged by the user. The backpack according to present invention provides a traditional parachute accessory for a user to use to evacuate a tall building and particular buildings with high floors of 50 floors and above.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A back pack with parachute comprising:
a main compartment;
a chute compartment, wherein the chute compartment includes a releasable parachute;
an air sensor, wherein the air sensor is adapted to enable the release of the parachute;
shoulder straps;
a connection ring on the inside surface of the backpack;
a waist strap extending from the connection ring; and
leg straps extending from the connection ring.

2. The back pack according to claim 1, wherein the air sensor includes an altimeter wherein the altimeter enables the release of the parachute.

3. The back pack according to claim 2, where the altimeter activates the release of the parachute after a predetermined distance.

4. The back pack according to claim 1, further including a pull cord.

5. The back pack according to claim 1, further including a storage pocket on an inner side of the backpack, where the storage pocket is adapted to store the waist strap and leg straps.
